(19) United States
(12) Patent Application Publication
(10) Pub. No.: US 2020/0099444 A1
(43) Pub. Date: Mar. 26, 2020

(54) DELAY MEASUREMENT METHOD AND STATION

(71) Applicant: Huawei Technologies Co., Ltd., Shenzhen (CN)

(72) Inventor: Bangxu LI, Wuhan (CN)

(21) Appl. No.: 16/696,755

(22) Filed: Nov. 26, 2019

Related U.S. Application Data
(63) Continuation of application No. PCT/CN2017/086619, filed on May 31, 2017.

(51) Int. Cl. H04B 10/077; H04B 10/079; H04Q 11/00

(52) U.S. Cl. CPC H04B 10/077; H04B 10/0795; H04Q 11/0062; H04Q 2011/0073; H04Q 2011/0045; H04Q 2213/13172; H04Q 11/0005

(57) ABSTRACT

Methods and stations for transmission delay measurements are disclosed. The method includes controlling, by a first station, an optical path selector to work in a first state, and selecting, by the first station, a first fiber to send a first OSC signal to a second station, where the first OSC signal includes a first time stamp. The method further includes controlling, by the first station, the optical path selector to work in a second state, and selecting, by the first station, the first fiber to receive a second OSC signal from the second station at a second receiving moment, where the second OSC signal includes a second time stamp. The method further includes calculating, by the first station, a unidirectional transmission delay between the first station and the second station based on a first sending moment, a first receiving moment, a second sending moment, and the second receiving moment.

### CROSS-REFERENCE TO RELATED APPLICATIONS

This application is a continuation of International Application No. PCT/CN2017/086619, filed on May 31, 2017, the disclosure of which is incorporated herein by reference in its entirety.

### TECHNICAL FIELD

This application relates to the field of optical communications technologies, and in particular, to a delay measurement method and a station.

### BACKGROUND

In a dense wavelength division multiplexing (DWDM) system, there is a C-band optical signal (C-BAND) transmission channel and an optical supervisory channel (OSC). The C-BAND transmission channel and the OSC channel have different wavelengths. The C-BAND transmission channel is used to transmit a service, and the OSC channel is used to transmit supervisory management information.

To implement time synchronization between any two stations in an optical transport network (OTN), a dedicated slot on an OSC channel is used to transmit time stamp information between two stations, to implement time synchronization between two stations that are in a fiber connection.

A “single-fiber bidirectional” manner is used in the prior art to measure a unidirectional transmission delay between stations, to perform time synchronization. As shown in FIG. 1A and FIG. 1B, which are a schematic diagram of a networking structure of an optical transport network in the prior art, an OSC signal is transmitted back and forth on a same fiber 1, and a transmission delay of the optical signal can be obtained through calculation. In one embodiment, as shown in FIG. 2, which is a schematic diagram of time stamp transmission, time stamp information is transmitted between two stations on an OSC channel, and a unidirectional transmission delay is obtained through calculation based on the time stamp information.

When the “single-fiber bidirectional” manner is used, two different wavelengths need to be used for back-and-forth transmission on the fiber. If a station A and a station B have a same sending wavelength, there is reflection when a signal sent by the station A passes through an optical multiplexer, and the signal is mixed with a signal sent by the station B. As a result, the station A cannot correctly receive the signal sent by the station B. For example, as shown in FIG. 1A and FIG. 1B, a sending wavelength of the station A is 1491 nm, and a sending wavelength of the station B is 1511 nm. However, during transmission on a long fiber, delays of transmission using two wavelengths are unequal (when a type of the long fiber is G652, and a length is 80 km, a transmission delay difference is 27 ns) due to dispersion of the fiber, an error of 13 ns is generated by obtaining a half of a sum of back-and-forth delays, and compensation cannot be performed.

Therefore, a unidirectional transmission delay between stations cannot be accurately measured by using the solution in the prior art.

### SUMMARY

This application provides a delay measurement method and a station, to accurately measure a unidirectional transmission delay between stations.

According to a first aspect of this application, a delay measurement method is provided, and includes: controlling, by a first station, an optical path selector to work in a first state, so that the first station selects a first fiber to send a first optical supervisory channel OSC signal to a second station, where the first OSC signal includes a first time stamp, and the first time stamp indicates a first sending moment at which the first station sends the first OSC signal; controlling, by the first station, the optical path selector to work in a second state, so that the first station selects the first fiber to receive a second OSC signal from the second station at a second receiving moment, where the second OSC signal includes a second time stamp, the second time stamp indicates a first receiving moment at which the second station receives the first OSC signal and a second sending moment at which the second station sends the second OSC signal, and a difference between a value of a wavelength used by the first OSC signal and a value of a wavelength used by the second OSC signal is less than a preset range; and calculating, by the first station, a unidirectional transmission delay between the first station and the second station based on the first sending moment, the first receiving moment, the second sending moment, and the second receiving moment. In this embodiment, the optical path selector is used to switch an optical path, so that two OSC signals including time stamps are transmitted on a same fiber in which a difference between wavelength values is less than the preset range, and a unidirectional transmission delay between two stations can be accurately measured based on the time stamps.

In one embodiment, after the first station selects the first fiber to send the first OSC signal to the second station, the method further includes: receiving, by the first station, an acknowledgement message from the second station, where the acknowledgement message is used to indicate that the second station has received the first OSC signal. In this embodiment, after receiving the first OSC signal, the second station sends the acknowledgement message to the first station, to acknowledge that the first OSC signal has been received, so that the first station can accurately switch an optical path. In another embodiment, the first station may alternatively switch an optical path a preset time after sending of the first OSC signal.

In another embodiment, after the calculating, by the first station, a unidirectional transmission delay between the first station and the second station based on the first sending moment, the first receiving moment, the second sending moment, and the second receiving moment, the method further includes: sending, by the first station, the unidirectional transmission delay to the second station. In this embodiment, after obtaining the unidirectional transmission delay through calculation, the first station sends the unidirectional transmission delay to the second station, so that the second station can accurately perform time synchronization based on the unidirectional transmission delay and a time of the first station.

In still another embodiment, after the sending, by the first station, the unidirectional transmission delay to the second station, the method further includes: sending, by the first station, a third OSC signal to the second station, where the third OSC signal includes an updated time of the first station. In this embodiment, the first station periodically sends the updated time of the first station, so that the second station can implement time synchronization with the first station based on the updated time of the first station and the unidirectional transmission delay.

According to another aspect of this application, a delay measurement method is provided, and includes: controlling, by the second station, an optical path selector to work in a first state, so that the second station selects a first fiber to receive a first optical supervisory channel OSC signal from the first station, where the first OSC signal includes a first time stamp, and the first time stamp indicates a first sending moment at which the first station sends the first OSC signal; and controlling, by the second station, the optical path selector to work in a second state, so that the second station selects the first fiber to send a second OSC signal to the first station, where the second OSC signal includes a second time stamp, the second time stamp indicates a first receiving moment at which the second station receives the first OSC signal and a second sending moment at which the second station sends the second OSC signal, and a difference between a value of a wavelength used by the first OSC signal and a value of a wavelength used by the second OSC signal is less than a preset range. In this embodiment, the optical path selector is used to switch an optical path, so that two OSC signals including time stamps are transmitted on a same fiber in which a difference between wavelength values is less than the preset range, and a unidirectional transmission delay between two stations can be accurately measured based on the time stamps.

In one embodiment, after the second station selects the first fiber to receive the first OSC signal from the first station, the method further includes: sending, by the second station, an acknowledgement message to the first station, where the acknowledgement message is used to indicate that the second station has received the first OSC signal. In this embodiment, after receiving the first OSC signal, the second station sends the acknowledgement message to the first station, to acknowledge that the first OSC signal has been received, so that the first station can accurately switch an optical path. In another embodiment, the first station may alternatively switch an optical path a preset time after sending of the first OSC signal.

In another embodiment, the controlling, by the second station, the optical path selector to work in a second state includes: controlling, by the second station based on a change of an optical power on the first fiber, the optical path selector to work in the second state. In this embodiment, the first station does not need to notify the second station of a change of an optical path, and when the first station switches a status of an optical path selector, the second station may switch a status of the optical path selector of the second station based on the change of the optical power on the fiber. In one embodiment, there is no light on the fiber, and the optical power is 0.

In still another embodiment, after the second station selects the first fiber to send the second OSC signal to the first station, the method further includes: receiving, by the second station, a unidirectional transmission delay sent by the first station. In this embodiment, after obtaining the unidirectional transmission delay through calculation, the first station sends the unidirectional transmission delay to the second station, so that the second station can perform time synchronization based on the unidirectional transmission delay and a time of the first station.

In still another embodiment, after the receiving, by the second station, a unidirectional transmission delay sent by the first station, the method further includes: synchronizing, by the second station, a time of the second station with a time of the first station based on the unidirectional transmission delay and the time of the first station. In this embodiment, the second station can accurately perform time synchronization based on the unidirectional transmission delay and the time of the first station.

In still another embodiment, after the second station performs time calibration based on the time of the first station, the method further includes: receiving, by the second station, a third OSC signal sent by the first station, where the third OSC signal includes an updated time of the first station; and updating, by the second station, the time of the second station based on the updated time of the first station and the unidirectional transmission delay. In this embodiment, the first station periodically sends the updated time of the first station, so that the second station can accurately implement time synchronization with the first station based on the updated time of the first station and the unidirectional transmission delay.

With reference to either of the foregoing aspects of this application, in one embodiment, the difference between the value of the wavelength used by the first OSC signal and the value of the wavelength used by the second OSC signal is 0. In this embodiment, a difference between values of wavelengths used by two OSC signals is 0, so that a measured unidirectional transmission delay can be completely error-free.

With reference to either of the foregoing aspects of this application, in another embodiment, the unidirectional transmission delay is a half of a difference between a first operation value and a second operation value, the first operation value is a difference between the second receiving moment and the first sending moment, and the second operation value is a difference between the second sending moment and the first receiving moment. In this embodiment, the unidirectional transmission delay is calculated based on moments at which each of two stations sends and receives OSC signals and that are recorded in time stamps.

With reference to either of the foregoing aspects of this application, in still another embodiment, the optical path selector is a 2×2 optical switch. In this embodiment, switching between two optical paths can be simply implemented by using the 2×2 optical switch.

According to still another aspect of this application, a first station is provided. The first station has a function of implementing behavior of the first station in the foregoing method. The function may be implemented by hardware, or may be implemented by hardware executing corresponding software. The hardware or software includes one or more modules corresponding to the function.

In one embodiment, the first station includes: an optical path control unit configured to control an optical path selector to work in a first state; a sending unit configured to select a first fiber to send a first optical supervisory channel OSC signal to a second station, where the first OSC signal includes a first time stamp, and the first time stamp indicates a first sending moment at which the first station sends the first OSC signal, where the optical path control unit is further configured to control the optical path selector to work in a second state; a receiving unit configured to select the first fiber to receive a second OSC signal from the second station at a second receiving moment, where the second OSC signal includes a second time stamp, the second time stamp indicates a first receiving moment at which the second station receives the first OSC signal and a second sending moment at which the second station sends the second OSC signal, and a difference between a value of a wavelength used by the first OSC signal and a value of a wavelength used by the second OSC signal is less than a preset range; and a calculation unit configured to calculate a unidirectional transmission delay between the first station and the second station based on the first sending moment, the first receiving moment, the second sending moment, and the second receiving moment.

In another embodiment, the first station includes: a controller, an optical path selector connected to the controller, and a fiber interface unit connected to the optical path selector, where the controller is configured to control the optical path selector to work in a first state, so that the fiber interface unit selects a first fiber to send a first optical supervisory channel OSC signal to a second station, where the first OSC signal includes a first time stamp, and the first time stamp indicates a first sending moment at which the first station sends the first OSC signal; the controller is further configured to control the optical path selector to work in a second state, so that the fiber interface unit selects the first fiber to receive a second OSC signal from the second station at a second receiving moment, where the second OSC signal includes a second time stamp, the second time stamp indicates a first receiving moment at which the second station receives the first OSC signal and a second sending moment at which the second station sends the second OSC signal, and a difference between a value of a wavelength used by the first OSC signal and a value of a wavelength used by the second OSC signal is less than a preset range; and the controller is further configured to calculate a unidirectional transmission delay between the first station and the second station based on the first sending moment, the first receiving moment, the second sending moment, and the second receiving moment.

Based on a same inventive concept, for a problem resolving principle and a beneficial effect of the apparatus, refer to the foregoing possible method embodiments of the station and the beneficial effect of the embodiments. Therefore, for implementation of the apparatus, refer to the implementation of the methods. Details are not described herein again.

According to still another aspect of this application, a second station is provided. The second station has a function of implementing behavior of the second station in the foregoing method. The function may be implemented by hardware, or may be implemented by hardware executing corresponding software. The hardware or software includes one or more modules corresponding to the function.

In one embodiment, the second station includes: an optical path control unit configured to control an optical path selector to work in a first state; a receiving unit configured to select a first fiber to receive a first optical supervisory channel OSC signal from the first station, where the first OSC signal includes a first time stamp, and the first time stamp indicates a first sending moment at which the first station sends the first OSC signal, where the optical path control unit is further configured to control the optical path selector to work in a second state; and a sending unit configured to select the first fiber to send a second OSC signal to the first station, where the second OSC signal includes a second time stamp, the second time stamp indicates a first receiving moment at which the second station receives the first OSC signal and a second sending moment at which the second station sends the second OSC signal, and a difference between a value of a wavelength used by the first OSC signal and a value of a wavelength used by the second OSC signal is less than a preset range.

In another embodiment, the second station includes: a controller, an optical path selector connected to the controller, and a fiber interface unit connected to the optical path selector, where the controller is configured to control the optical path selector to work in a first state, so that the fiber interface unit selects a first fiber to receive a first optical supervisory channel OSC signal from a first station, where the first OSC signal includes a first time stamp, and the first time stamp indicates a first sending moment at which the first station sends the first OSC signal; the controller is further configured to control the optical path selector to work in a second state, so that the fiber interface unit selects the first fiber to send a second OSC signal to the first station, where the second OSC signal includes a second time stamp, the second time stamp indicates a first receiving moment at which the second station receives the first OSC signal and a second sending moment at which the second station sends the second OSC signal, and a difference between a value of a wavelength used by the first OSC signal and a value of a wavelength used by the second OSC signal is less than a preset range.

Based on a same inventive concept, for a problem resolving principle and a beneficial effect of the apparatus, refer to the foregoing method embodiments of the station and the beneficial effect of the embodiments. Therefore, for implementation of the apparatus, refer to the implementation of the methods. Details are not described herein again.

Still another aspect of this application provides a computer-readable storage medium. The computer-readable storage medium stores an instruction, and when the instruction runs on a computer, the computer performs the methods in the foregoing aspects.

Still another aspect of this application provides a communications chip, storing instructions. When the instructions run on a network device or a terminal device, the network device or the terminal device performs the methods in the foregoing aspects.

Still another aspect of this application provides a computer program product including instructions. When the instructions run on a computer, the computer performs the methods in the foregoing aspects.

### DESCRIPTION OF DRAWINGS

To describe the technical solutions in the embodiments of the present disclosure or in the background more clearly, the following describes the accompanying drawings required for describing the embodiments of the present disclosure or the background.

FIG. 1A and FIG. 1B are a schematic diagram of a networking structure of an optical transport network in the prior art;

FIG. 2 is a schematic diagram of time stamp transmission in the prior art;

FIG. 3A and FIG. 3B are a schematic diagram of a networking structure of an optical transport network according to one embodiment;

FIG. 4 is a schematic structural diagram of an optical transport network device according to one embodiment;

FIG. 5 is a schematic diagram of a working state of an optical switch according to one embodiment;

FIG. 6A and FIG. 6B are a schematic diagram of a networking structure of another optical transport network according to one embodiment;

FIG. 7 is an interaction flowchart of a delay measurement method according to one embodiment;

FIG. 8 is a schematic diagram of time stamp transmission according to one embodiment;

FIG. 9A and FIG. 9B are a schematic diagram of a networking structure of still another optical transport network according to one embodiment;

FIG. 10 is a schematic diagram of a format of an OTN frame according to one embodiment;

FIG. 11 is a schematic interaction flowchart of another delay measurement method according to one embodiment;

FIG. 12 is a schematic structural diagram of a station according to one embodiment; and

FIG. 13 is a schematic structural diagram of another station according to one embodiment.

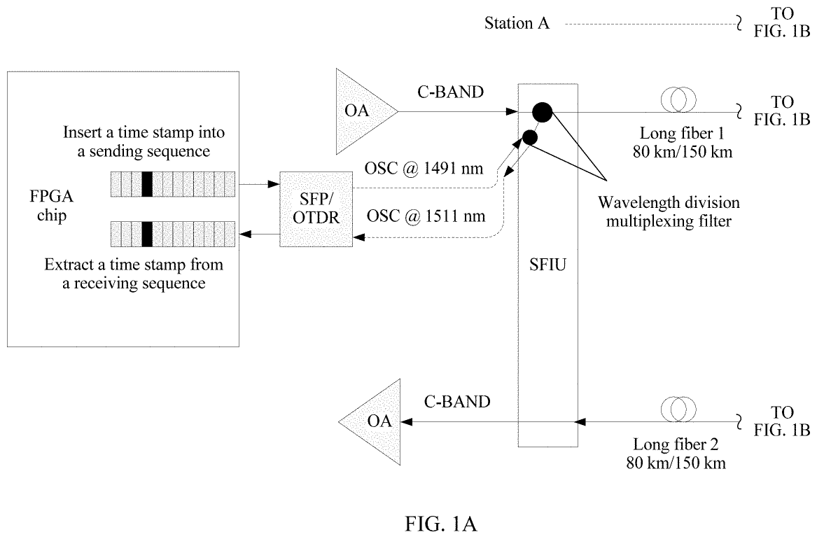

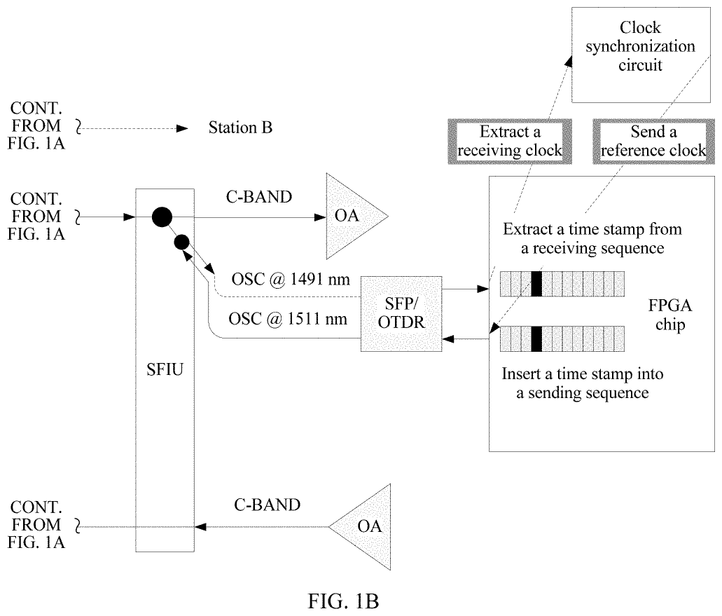

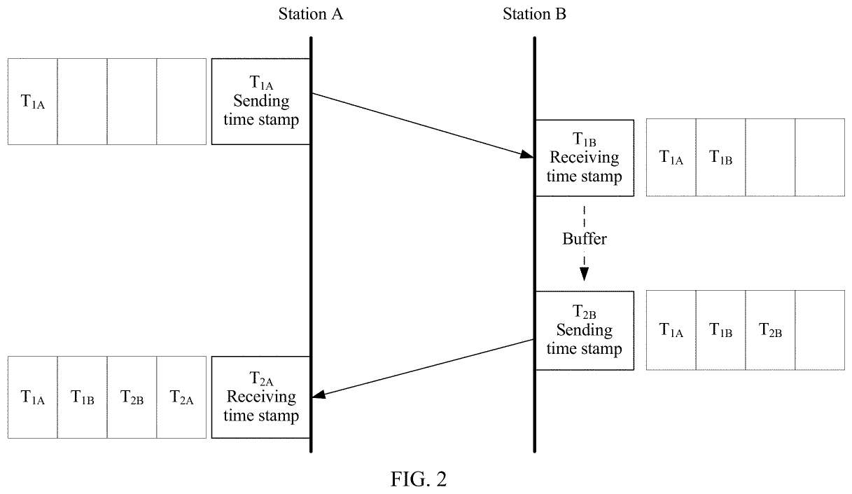

### DESCRIPTION OF EMBODIMENTS

The following describes the embodiments of the present disclosure with reference to the accompanying drawings in the embodiments of the present disclosure.

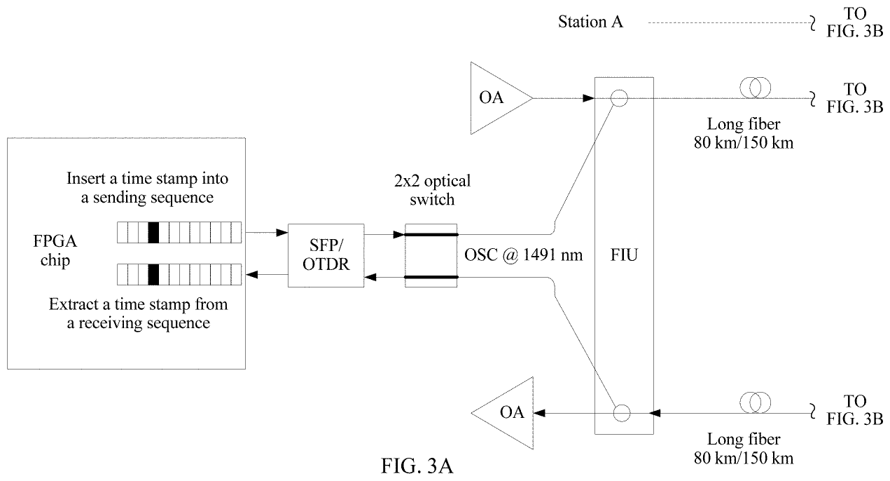

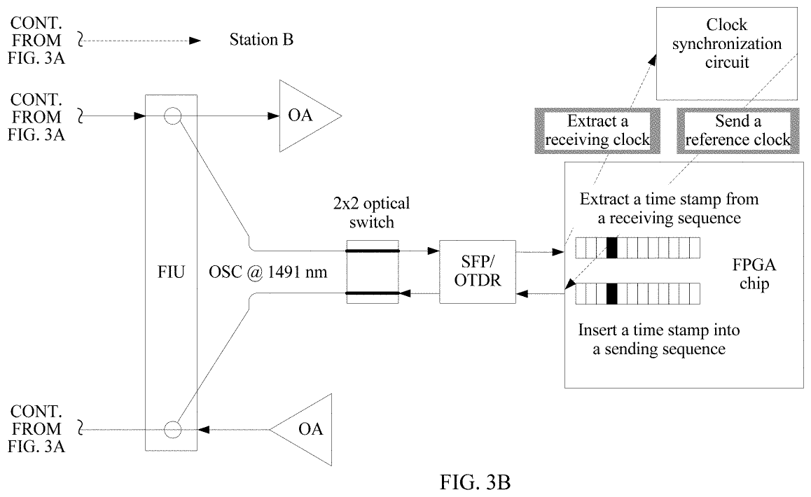

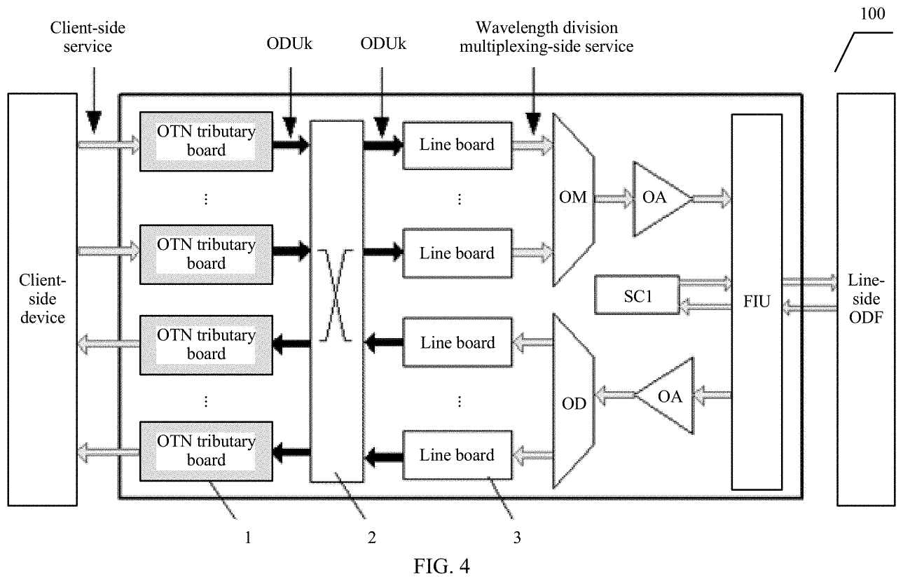

FIG. 3A and FIG. 3B are a schematic diagram of a networking structure of an optical transport network according to one embodiment, and shows a structure of optical communication between a first station (station A in the figure) and a second station (station B in the figure). The station A and the station B may be OTN devices. A general structure of an OTN device is shown in FIG. 4. In FIG. 4, an OTN device 100 includes a tributary board 1, a cross-connect board 2, and a line board 3. A service transmission direction may be from a client side to a line side, or may be from a line side to a client side. A service sent or received by the client side is referred to as a client-side service, and a service received or sent by the line side is referred to as a WDM-side service. Service processing procedures in two directions are mutually reverse, and this embodiment is described by using the direction from the client side to the line side as an example.

In one embodiment, tributary board 1 completes encapsulation and mapping on a client service. The client service includes a plurality of service types, for example, a packet service and a constant bit rate (CBR) service. The packet service may include an Ethernet media access control (MAC) packet service, a flexible Ethernet (FlexE) packet service, a multiprotocol label switching (MPLS) packet service, an internet protocol (IP) packet service, or the like. The CBR service may include a synchronous digital hierarchy (SDH) service, an OTN service, a common public radio interface (CPRI) service, or a service of another time division multiplexing (TDM) type. In one embodiment, the tributary board 1 is configured to: receive a client service from the client side, encapsulate the received client service, map the client service to an optical data unit (ODU) signal, and add corresponding OTN management supervisory overheads. On the tributary board 1, the ODU signal may be ODUflex, ODU0, ODU1, ODU2, ODU2e, ODU3, ODU4, or the like, and the OTN management supervisory overheads may be ODU overheads. Different types of client services may be encapsulated and are then mapped to different ODU signals in different manners.

In one embodiment, cross-connect board 2 completes full cross connection between the tributary board and the line board, and implements flexible cross connection grooming on an ODU signal. In one embodiment, the cross-connect board may transmit an ODU signal from any tributary board to any line board, or transmit an OTU signal from any line board to any line board, or may transmit a client signal from any tributary board to any tributary board.

In one embodiment, line board 3 forms an optical transport unit (OTU) signal by using an ODU signal, and sends the OTU signal to the line side. Before forming an OTU signal by using an ODU signal, the line board 3 may multiplex a plurality of ODU signals having lower rates onto ODU signals having higher rates. Corresponding OTN management supervisory overheads are added to an ODU signal, to form an OTU signal and send the OTU signal to an optical transport channel on the line side. On the line board 3, the ODU signal may be ODU1, ODU2, ODU3, ODU4, ODUCn, or the like, and the OTU signal (which may be multiplexed or may not be multiplexed) may be OTU1, OTU2, OTU3, OTU4, OTUCn, or the like. The OTN management supervisory overheads may be OTU overheads.

A line-side service signal passes through an OM or OD, then is amplified by using an optical amplifier (OA), and is sent by using a fiber interface unit (FIU).

The foregoing describes transmission of a service signal. In the optical transport network, there is a further type of signal: an OSC signal. In the structural diagram shown in FIG. 3A and FIG. 3B, an OSC signal generated by an OSC unit is sent by using the FIU. A component, namely, SC1, for OSC signal transport in each station may include a controller, and a small form-factor pluggable (SFP), an optical path selector, and a fiber interface unit that are sequentially connected to the controller. In one embodiment, the controller is an electrical chip, is responsible for inserting and extracting a time stamp signal, finally sends/receives a 155 M electrical signal of an OSC channel, and is a master control chip of other elements in the station. In FIG. 3A and FIG. 3B, the controller is an FPGA chip. The SFP is an optical-electrical conversion module, receives an electrical signal of the controller, internally performs electrical-to-optical conversion on the electrical signal, and sends the optical signal. In addition, the SFP receives an optical signal, internally performs optical-to-electrical conversion on the optical signal, and sends an electrical signal. The SFP may further include an optical time domain reflectometer (OTDR). In this embodiment, an SFP in the station A is connected to an FIU by using a first optical path selector, and an SFP in the station B is connected to an FIU by using a second optical path selector. The first/second optical path selector is configured to select an optical path based on a control instruction.

A “single-fiber unidirectional” optical communication manner is used in this embodiment. As shown in FIG. 3A and FIG. 3B, an optical signal is sent from the station A to the station B through a fiber 1, and an optical signal fed back by the station B is sent to the station A through a fiber 2. In this way, a prior-art case in which a signal sent by a station A is mixed with a signal sent by a station B when passing through an optical multiplexer does not exist.

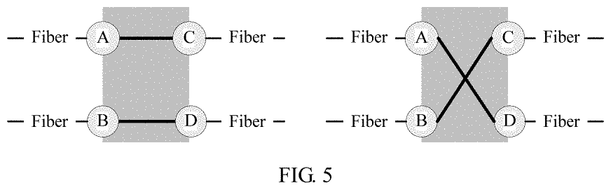

In FIG. 3A and FIG. 3B, the first optical path selector in the station A and the second optical path selector in the station B each are a 2×2 optical switch, and switching between two optical paths can be simply implemented by using the 2×2 optical switch. The 2×2 optical switch is a four-port optical component, the 2×2 optical switch may work in two states, and the controller controls switching between the two states. FIG. 5 is a schematic diagram of a working state of an optical switch in this embodiment. The left figure of FIG. 5 shows a state 1 of the optical switch, a port A is connected to a port C, and a port B is connected to a port D. The right figure of FIG. 5 shows a state 2 of the optical switch, the port A is connected to the port D, and the port B is connected to the port C. In addition, an optical multiplexer/optical demultiplexer is configured to perform optical multiplexing on an OSC signal and a C-BAND signal/optical demultiplexing on an OSC signal and a C-BAND signal. The optical multiplexer/optical demultiplexer may be an FIU or an SFIU. In addition, if the station A is a primary station, and the station B is a secondary station, the station B may further include a clock synchronization circuit connected to the controller, to implement clock synchronization with the station A.

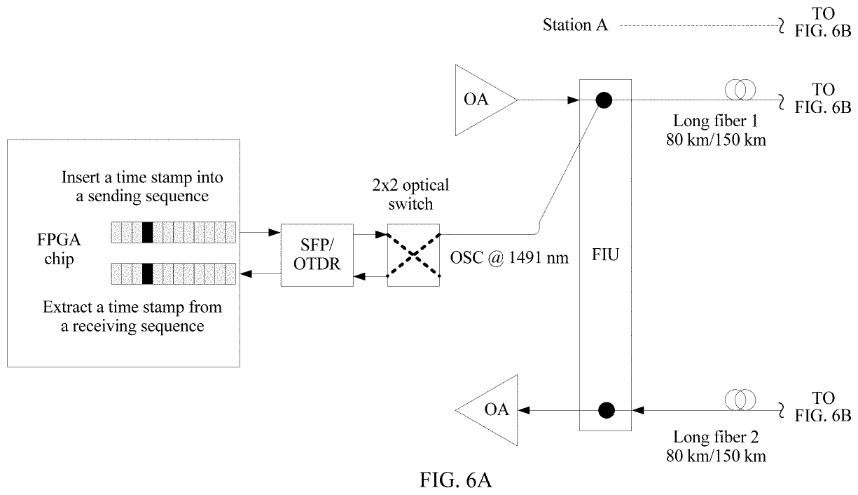

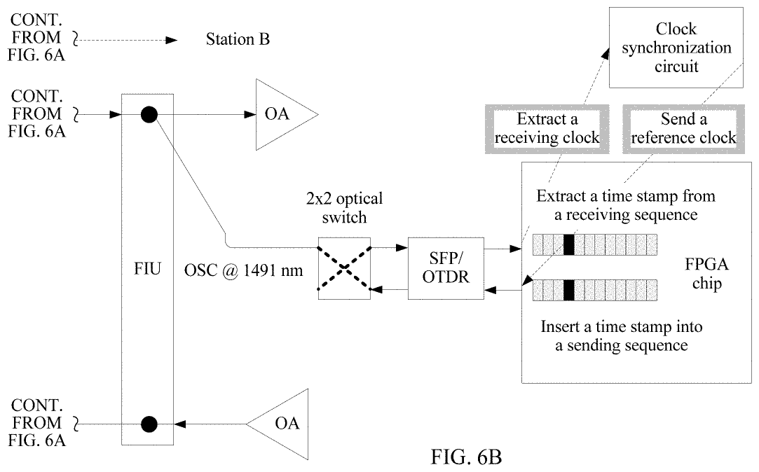

In one embodiment, during delay measurement, measurement is performed independently for each fiber. For example, a unidirectional transmission delay of the fiber 1 or the fiber 2 in FIG. 3A and FIG. 3B is measured. Therefore, if the unidirectional transmission delay of the fiber 1 is measured, as shown in FIG. 6A and FIG. 6B, which are a schematic diagram of a networking structure of another optical transport network according to one embodiment, the optical switch may not be connected to the fiber 2, and this is half-duplex communication. If the unidirectional transmission delay of the fiber 2 is measured, the optical switch may not be connected to the fiber 1.

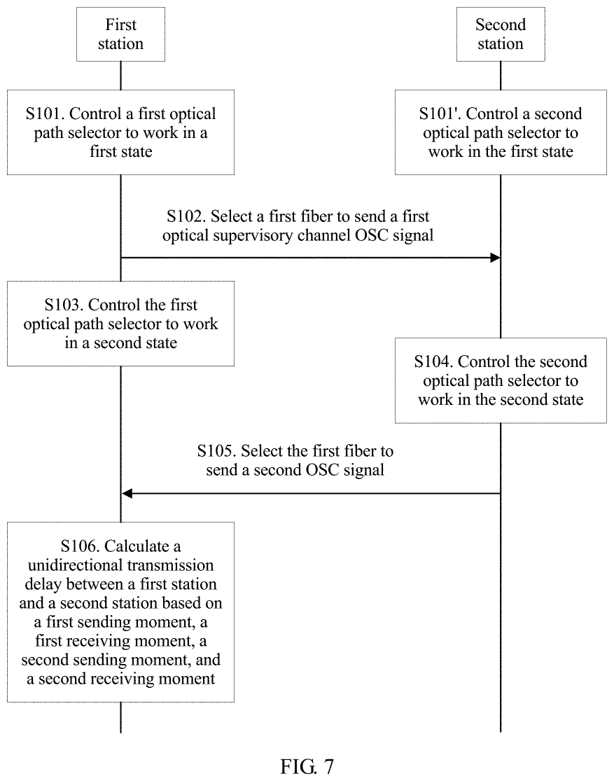

FIG. 7 is an interaction flowchart of a delay measurement method according to one embodiment. The method is applied to measurement of a delay between two stations. The method may include the following steps:

S101. A first station controls a first optical path selector to work in a first state.

S101′. A second station controls a second optical path selector to work in the first state.

S102. The first station selects a first fiber to send a first OSC signal to the second station, where the first OSC signal includes a first time stamp, and the first time stamp indicates a first sending moment at which the first station sends the first OSC signal.

S103. The first station controls the first optical path selector to work in a second state.

S104. The second station controls the second optical path selector to work in the second state.

S105. The second station selects the first fiber to send a second OSC signal to the first station, where the second OSC signal includes a second time stamp, the second time stamp indicates a first receiving moment at which the second station receives the first OSC signal and a second sending moment at which the second station sends the second OSC signal, and a difference between a value of a wavelength used by the first OSC signal and a value of a wavelength used by the second OSC signal is less than a preset range.

S106. The first station calculates a unidirectional transmission delay between the first station and the second station based on the first sending moment, the first receiving moment, the second sending moment, and a second receiving moment.

Specific working manners of two stations are described below with reference to the foregoing procedure:

First, as shown in step S101 and step S101′, after the stations are powered on, a controller of each station controls an optical switch to work in a state 1 (shown by solid lines of the optical switch in FIG. 5). Controllers of a station A and a station B send and receive OSC signals, to set up OSC communication. In addition, because serial transmission is performed between the station A and the station B, the station B extracts a clock in an OSC signal by using a clock synchronization circuit, to implement clock synchronization between the station B and the station A.

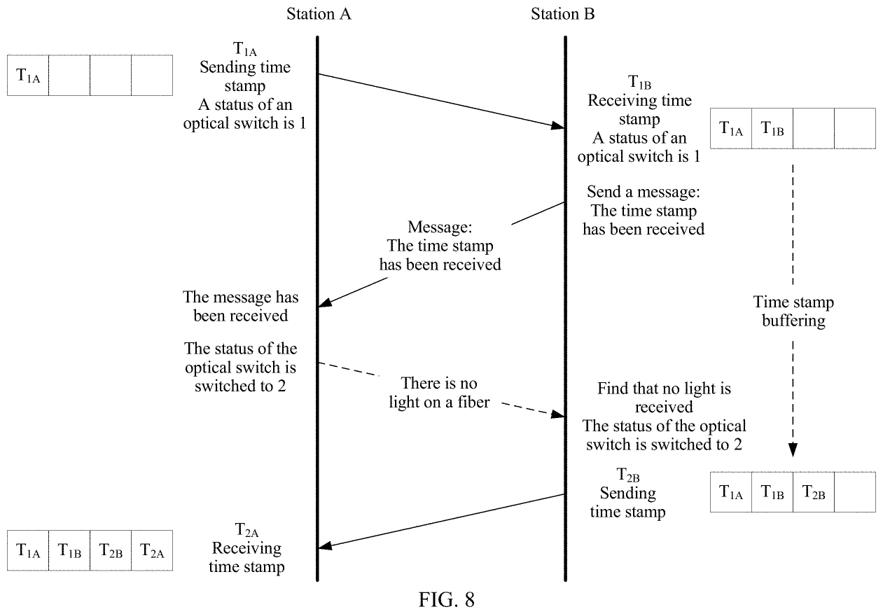

Then, as shown in step S102, the station A sends a first OSC signal to the station B, and the station B receives the first OSC signal. In one embodiment, the first OSC signal is sent by the station A to the station B through a fiber 1. As shown in FIG. 8, which is a schematic diagram of time stamp transmission according to one embodiment, the first OSC signal includes a first time stamp, and the first time stamp includes a first sending moment T₁A at which the station A sends the first OSC signal. When receiving the first OSC signal, the station B records a first receiving moment T₁B, stores the T₁B in a second time stamp, and then buffers the second time stamp.

Subsequently, as shown in step S103, the station A switches the optical switch to work in a state 2, and then, as shown in step S104, the station B also switches the optical switch to work in the state 2.

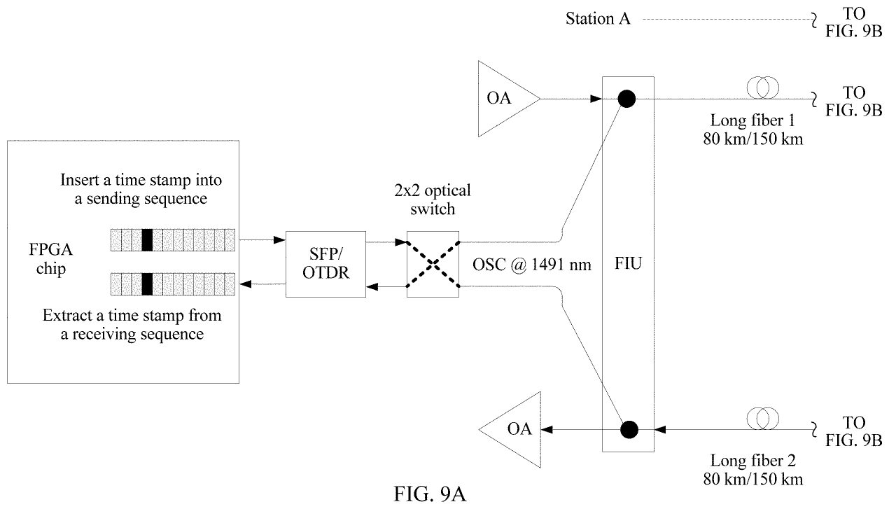

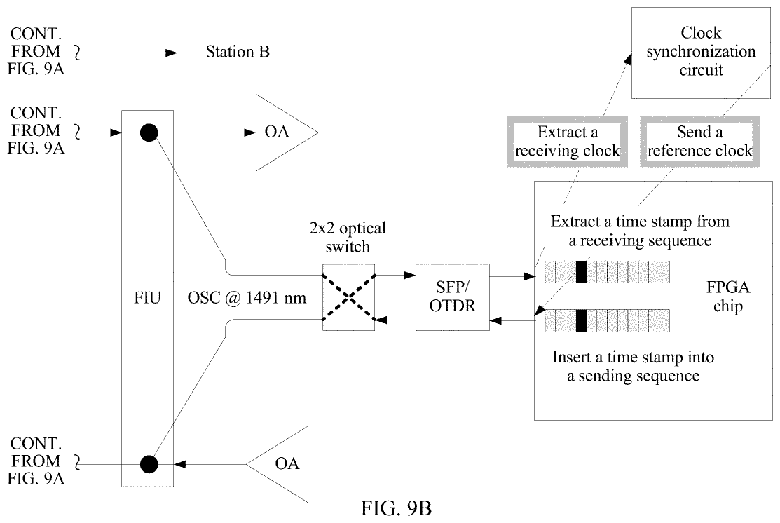

Subsequently, as shown in step S105 and FIG. 8, the station B adds a sending moment T₂B to the buffered second time stamp, and sends a second OSC signal to the station A. The second OSC signal includes the second time stamp. In one embodiment, as shown in FIG. 9A and FIG. 9B, which are a schematic diagram of a networking structure of another optical transport network according to one embodiment, the controller of the station B sends the second OSC signal from the optical switch (shown by dashed lines of the optical switch of the station B in FIG. 9A and FIG. 9B) to the station A through the fiber 1, and the station A transmits the received second OSC signal from the optical switch (shown by dashed lines of the optical switch of the station A in FIG. 9A and FIG. 9B) to the controller of the station A. The second time stamp includes the first receiving moment T₁B and a second sending moment T₂B. In addition, the second time stamp may further include the first sending moment T₁A. When receiving the second OSC signal at a second receiving moment T₂A, the station A stores the second receiving moment T₂A in a time stamp.

Finally, as shown in step S106, the station A calculates a unidirectional transmission delay D between the station A and the station B based on the first sending moment T₁A, the first receiving moment T₁B, the second sending moment T₂B, and the second receiving moment T₂A. In one embodiment, the unidirectional transmission delay is a half of a difference between a first operation value and a second operation value, the first operation value is a difference between the second receiving moment and the first sending moment, and the second operation value is a difference between the second sending moment and the first receiving moment. In this example, the unidirectional transmission delay D=(T₂A−T₁A−(T₂B−T₁B))/2. The first operation value (T₂A−T₁A) is a total time of transmitting a time stamp back and forth on the fiber 1, and the second operation value (T₂B−T₁B) is a time within which the time stamp is buffered in the station B. In this embodiment, the difference between the value of the wavelength used by the first OSC signal and the value of the wavelength used by the second OSC signal is less than the preset range, and the preset range may be a minimal value approaching 0. For example, the difference between the value of the wavelength used by the first OSC signal and the value of the wavelength used by the second OSC signal may be 0. Therefore, the unidirectional transmission delay obtained through calculation has a minimal error.

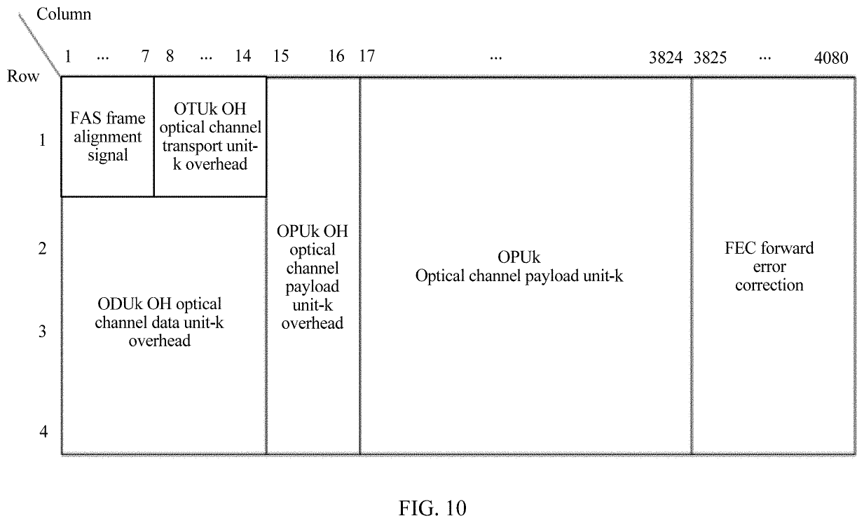

In this embodiment, the first OSC signal and the second OSC signal may use a frame structure of an OTN frame. FIG. 10 is a schematic diagram of a format of an OTN frame according to one embodiment. As shown in FIG. 10, the OTN frame uses a 4080 columns×4 rows standard modular structure. 16 columns in a header of the OTN frame are overhead bytes, 3808 columns in the middle are payloads, and 256 columns in the tail are forward error correction (FEC) check bytes. The OTN frame includes frame alignment signal (FAS) bytes in column 1 to column 7 in row 1, where the FAS bytes are used to provide a frame synchronization and positioning function, and a seventh byte in the FAS bytes is a multi-frame signal (MFAS), and is used to indicate overhead allocation when a plurality of pieces of client service data are carried in a time division multiplexing manner; optical channel transport unit-k overhead (OTUk OH) bytes in column 8 to column 14 in row 1, where the OTUk OH bytes are used to provide a network management function at an optical channel transport unit level; optical channel data unit-k overhead (ODUk OH) bytes in column 1 to column 14 in row 2 to row 4, where the ODUk OH bytes are used to provide a maintenance and operation function; OPUk OH (optical channel payload unit-k overhead) bytes in column 15 to column 16, where the OPUk OH bytes are used to provide a client service data adaption function, the OPUk OH bytes include a payload structure identifier (PSI), the PSI corresponds to 0 to 255 possible values under indication of the MFAS, a zeroth byte is a client service data type indication (PT), and other bytes are reserved (RES) bytes, and are reserved for use in future extension; optical channel payload unit-k (OPUk) bytes in column 17 to column 3824, where the OPUk bytes are used to provide a client service data carrying function, and to-be-transmitted client service data is encapsulated into the OPUk; and FEC bytes in column 3825 to column 4080, where the FEC bytes are used to provide an error detection and correction function. A coefficient k indicates a supported bit rate, and different bit rates correspond to different types of OPUk, ODUk, and OTUk, where k=0 indicates that a bit rate is 1.25 Gbit/s, k=1 indicates that a bit rate is 2.5 Gbit/s, k=2 indicates that a bit rate is 10 Gbit/s, k=3 indicates that a bit rate is 40 Gbit/s, and k=4 indicates that a bit rate is 100 Gbit/s. The OPUk and the OPUk OH form an OPUk frame, the OPUk frame, the ODUk OH, and the FAS form an ODUk frame, and the ODUk frame, the OTUk OH, and the FEC form an OTUk frame.

In this embodiment, the first time stamp and the second time stamp are located in the optical channel payload unit-k bytes in column 17 to column 3824.

According to the delay measurement method provided in this embodiment, the optical path selector is used to switch an optical path, so that two OSC signals including time stamps are transmitted on a same fiber in which a difference between wavelength values is less than the preset range, and a unidirectional transmission delay between two stations can be accurately measured based on the time stamps.

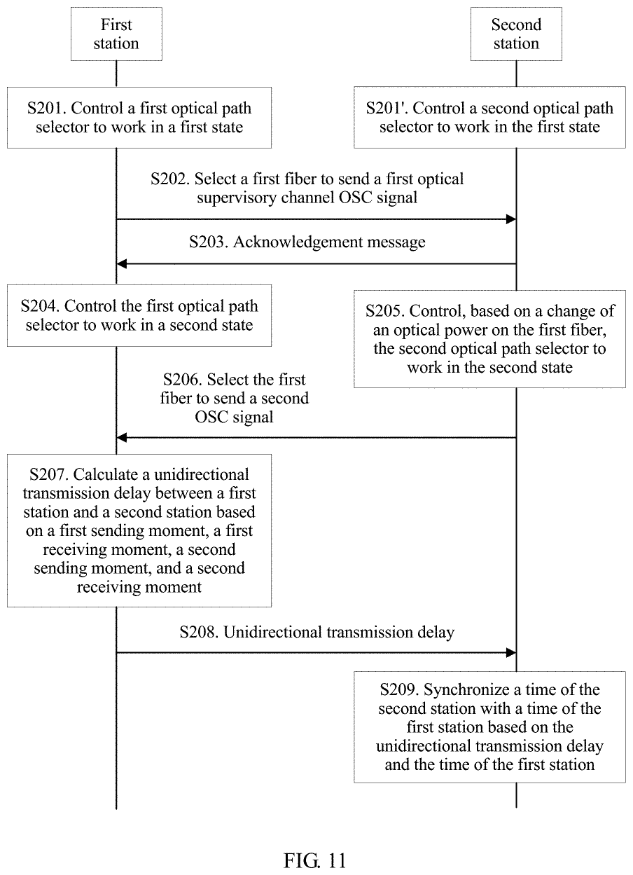

FIG. 11 is a schematic interaction flowchart of another delay measurement method according to one embodiment. A difference between the method and the method in the foregoing embodiment lies in that:

After the first station sends the first OSC signal to the second station, the method further includes step S203: The second station sends an acknowledgement message to the first station, where the acknowledgement message is used to indicate that the second station has received the first OSC signal. The first station receives the acknowledgement message. In one embodiment, as shown in FIG. 8, a station B sends an acknowledgement message to a station A, to acknowledge that a first time stamp has been received. Because in this case, an optical switch still works in a state 1, the acknowledgement message is transmitted to the station A through a fiber 2.

In another embodiment, the station B may not send an acknowledgement message to the station A, and instead, the station A switches a status of an optical switch to a state 2 a specified time after sending of a first OSC signal.

In addition, the second station controls the second optical path selector to work in a second state. In one embodiment, the second station controls, based on a change of an optical power on the first fiber, the second optical path selector to work in the second state. In one embodiment, an SFP connected to an optical switch in the station B has two fixed ports, one port is a transmit port, and the other port is a receive port. For example, when the optical switch works in the state 1, an OSC signal is normally received by the receive port of the SFP through the optical switch. However, when the optical switch is switched to the state 2, the ports of the SFP connected to the optical switch are exchanged with each other, and the original receive port of the SFP cannot detect the OSC signal. In other words, a receive optical power becomes 0. Then, a controller of the station B controls, based on the change of the optical power on the fiber, the optical switch of the station B to work in the state 2.

In addition, after the first station sends a unidirectional transmission delay to the second station, the method further includes step S209: The second station synchronizes a time of the second station with a time of the first station based on the unidirectional transmission delay and the time of the first station. In one embodiment, after receiving the unidirectional transmission delay, the station B may further extract a system time of the station A from an optical signal, and subtract the unidirectional transmission delay from the system time of the station A to obtain a system time of the station B, to implement time synchronization between the station B serving as a secondary station and the station A serving as a primary station.

In addition, after step S209, the method may further include a step (not shown): The first station sends a third OSC signal to the second station, where the third OSC signal includes an updated time of the first station. The second station receives the third OSC signal sent by the first station, where the third OSC signal includes the updated time of the first station. The second station updates the time of the second station based on the updated time of the first station and the unidirectional transmission delay. In one embodiment, the first station periodically sends the updated time of the first station, so that the second station can implement time synchronization with the first station based on the updated time of the first station and the unidirectional transmission delay.

According to the delay measurement method provided in this embodiment, the optical path selector is used to switch an optical path, so that two OSC signals including time stamps are transmitted on a same fiber in which a difference between wavelength values is less than a preset range, and a unidirectional transmission delay between two stations can be accurately measured based on the time stamps. The secondary station may further implement time synchronization with the primary station based on the unidirectional transmission delay.

The foregoing describes in detail the method in the embodiments of the present disclosure, and the following provides an apparatus in an embodiment of the present disclosure.

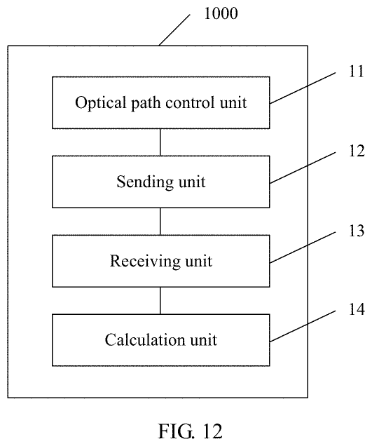

FIG. 12 is a schematic structural diagram of a station according to one embodiment. The station 1000 may include:

an optical path control unit 11 configured to control an optical path selector to work in a first state;

a sending unit 12 configured to select a first fiber to send a first optical supervisory channel OSC signal to a second station, where the first OSC signal includes a first time stamp, and the first time stamp indicates a first sending moment at which the station 1000 sends the first OSC signal, where

the optical path control unit 11 is further configured to control the optical path selector to work in a second state;

a receiving unit 13 configured to select the first fiber to receive a second OSC signal from the second station at a second receiving moment, where the second OSC signal includes a second time stamp, the second time stamp indicates a first receiving moment at which the second station receives the first OSC signal and a second sending moment at which the second station sends the second OSC signal, and a difference between a value of a wavelength used by the first OSC signal and a value of a wavelength used by the second OSC signal is less than a preset range; and

a calculation unit 14 configured to calculate a unidirectional transmission delay between the station 1000 and the second station based on the first sending moment, the first receiving moment, the second sending moment, and the second receiving moment.

In one embodiment, the difference between the value of the wavelength used by the first OSC signal and the value of the wavelength used by the second OSC signal is 0. In this embodiment, a difference between values of wavelengths used by two OSC signals is 0, so that a measured unidirectional transmission delay can be completely error-free.

In another embodiment, the unidirectional transmission delay is a half of a difference between a first operation value and a second operation value, the first operation value is a difference between the second receiving moment and the first sending moment, and the second operation value is a difference between the second sending moment and the first receiving moment. In this embodiment, the unidirectional transmission delay is calculated based on moments at which each of two stations sends and receives OSC signals and that are recorded in time stamps.

In still another embodiment, the sending unit 12 is further configured to send the unidirectional transmission delay to the second station. In this embodiment, after obtaining the unidirectional transmission delay through calculation, the station 1000 sends the unidirectional transmission delay to the second station, so that the second station can accurately perform time synchronization based on the unidirectional transmission delay and a time of the station 1000.

In still another embodiment, the receiving unit 13 is further configured to receive an acknowledgement message from the second station, where the acknowledgement message is used to indicate that the second station has received the first OSC signal. In this embodiment, after receiving the first OSC signal, the second station sends the acknowledgement message to the station 1000, to acknowledge that the first OSC signal has been received, so that the station 1000 can accurately switch an optical path. In another embodiment, the station 1000 may alternatively switch an optical path a preset time after sending of the first OSC signal.

In still another embodiment, the optical path selector is a 2×2 optical switch. In this embodiment, switching between two optical paths can be simply implemented by using the 2×2 optical switch.

In still another embodiment, the sending unit 12 is further configured to send a third OSC signal to the second station, where the third OSC signal includes an updated time of the station 1000. In this embodiment, the station 1000 periodically sends the updated time of the station 1000, so that the second station can implement time synchronization with the station 1000 based on the updated time of the station 1000 and the unidirectional transmission delay.

According to the station provided in this embodiment, the optical path selector is used to switch an optical path, so that two OSC signals including time stamps are transmitted on a same fiber in which a difference between wavelength values is less than the preset range, and a unidirectional transmission delay between two stations can be accurately measured based on the time stamps.

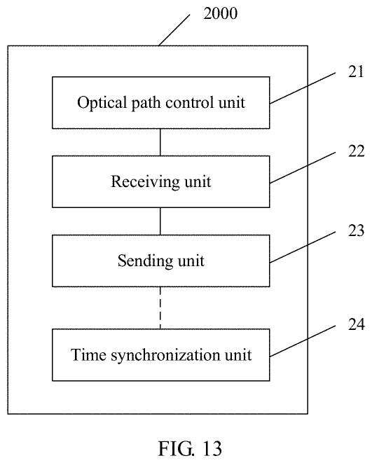

FIG. 13 is a schematic structural diagram of another station according to one embodiment. The station 2000 may include:

an optical path control unit 21 configured to control an optical path selector to work in a first state;

a receiving unit 22 configured to select a first fiber to receive a first optical supervisory channel OSC signal from the first station, where the first OSC signal includes a first time stamp, and the first time stamp indicates a first sending moment at which the first station sends the first OSC signal, where

the optical path control unit 21 is further configured to control the optical path selector to work in a second state; and

a sending unit 23 configured to select the first fiber to send a second OSC signal to the first station, where the second OSC signal includes a second time stamp, the second time stamp indicates a first receiving moment at which the station 2000 receives the first OSC signal and a second sending moment at which the station 2000 sends the second OSC signal, and a difference between a value of a wavelength used by the first OSC signal and a value of a wavelength used by the second OSC signal is less than a preset range.

In one embodiment, the difference between the value of the wavelength used by the first OSC signal and the value of the wavelength used by the second OSC signal is 0. In this embodiment, a difference between values of wavelengths used by two OSC signals is 0, so that a measured unidirectional transmission delay can be completely error-free.

In another embodiment, the sending unit 23 is further configured to send an acknowledgement message to the first station, where the acknowledgement message is used to indicate that the station 2000 has received the first OSC signal. In this embodiment, after receiving the first OSC signal, the station 2000 sends the acknowledgement message to the first station, to acknowledge that the first OSC signal has been received, so that the first station can accurately switch an optical path. In another embodiment, the first station may alternatively switch an optical path a preset time after sending of the first OSC signal.

In still another embodiment, the optical path control unit 21 is configured to control, based on a change of an optical power on the first fiber, the optical path selector to work in the second state. In this embodiment, the first station does not need to notify the station 2000 of a change of an optical path, and when the first station switches a status of an optical path selector, the station 2000 may switch a status of the optical path selector of the station 2000 based on the change of the optical power on the fiber. In one embodiment, there is no light on the fiber, and the optical power is 0.

In still another embodiment, the receiving unit 22 is further configured to receive a unidirectional transmission delay sent by the first station. In this embodiment, after obtaining the unidirectional transmission delay through calculation, the first station sends the unidirectional transmission delay to the station 2000, so that the station 2000 can perform time synchronization based on the unidirectional transmission delay and a time of the first station.

In still another embodiment, the station 2000 may further include: a time synchronization unit 24 (connected by using a dashed line in the figure), configured to synchronize a time of the station 2000 with a time of the first station based on the unidirectional transmission delay and the time of the first station. In this embodiment, the station 2000 can accurately perform time synchronization based on the unidirectional transmission delay and the time of the first station.

In still another embodiment, the receiving unit 22 is further configured to receive a third OSC signal sent by the first station, where the third OSC signal includes an updated time of the first station. The station 2000 updates the time of the station 2000 based on the updated time of the first station and the unidirectional transmission delay. In this embodiment, the first station periodically sends the updated time of the first station, so that the station 2000 can accurately implement time synchronization with the first station based on the updated time of the first station and the unidirectional transmission delay.

In still another embodiment, the unidirectional transmission delay is a half of a difference between a first operation value and a second operation value, the first operation value is a difference between a second receiving moment and the first sending moment, and the second operation value is a difference between the second sending moment and the first receiving moment. In this embodiment, the unidirectional transmission delay is calculated based on moments at which each of two stations sends and receives OSC signals and that are recorded in time stamps.

In still another embodiment, the optical path selector is a 2×2 optical switch. In this embodiment, switching between two optical paths can be simply implemented by using the 2×2 optical switch.

According to the station provided in this embodiment, the optical path selector is used to switch an optical path, so that two OSC signals including time stamps are transmitted on a same fiber in which a difference between wavelength values is less than the preset range, and a unidirectional transmission delay between two stations can be accurately measured based on the time stamps.

An embodiment of the present disclosure further provides still another first station. A hardware structure of the first station is shown by an OSC signal sending structure in a station A in FIG. 3A and FIG. 3B or FIG. 6A and FIG. 6B. The first station may include a controller, an optical path selector connected to the controller, and a fiber interface unit connected to the optical path selector. In FIG. 3A and FIG. 3B, and FIG. 6A and FIG. 6B, the controller is an FPGA chip, the optical path selector is a 2×2 optical switch, and the fiber interface unit is an FIU.

The controller is configured to control the optical path selector to work in a first state, so that the fiber interface unit selects a first fiber to send a first optical supervisory channel OSC signal to a second station, where the first OSC signal includes a first time stamp, and the first time stamp indicates a first sending moment at which the first station sends the first OSC signal.

The controller is further configured to control the optical path selector to work in a second state, so that the fiber interface unit selects the first fiber to receive a second OSC signal from the second station at a second receiving moment, where the second OSC signal includes a second time stamp, the second time stamp indicates a first receiving moment at which the second station receives the first OSC signal and a second sending moment at which the second station sends the second OSC signal, and a difference between a value of a wavelength used by the first OSC signal and a value of a wavelength used by the second OSC signal is less than a preset range.

The controller is further configured to calculate a unidirectional transmission delay between the first station and the second station based on the first sending moment, the first receiving moment, the second sending moment, and the second receiving moment.

In one embodiment, the difference between the value of the wavelength used by the first OSC signal and the value of the wavelength used by the second OSC signal is 0. In this embodiment, a difference between values of wavelengths used by two OSC signals is 0, so that a measured unidirectional transmission delay can be completely error-free.

In another embodiment, the unidirectional transmission delay is a half of a difference between a first operation value and a second operation value, the first operation value is a difference between the second receiving moment and the first sending moment, and the second operation value is a difference between the second sending moment and the first receiving moment. In this embodiment, the unidirectional transmission delay is calculated based on moments at which each of two stations sends and receives OSC signals and that are recorded in time stamps.

In still another embodiment, the fiber interface unit is further configured to send the unidirectional transmission delay to the second station. In this embodiment, after obtaining the unidirectional transmission delay through calculation, the first station sends the unidirectional transmission delay to the second station, so that the second station can accurately perform time synchronization based on the unidirectional transmission delay and a time of the first station.

In still another embodiment, the fiber interface unit is further configured to receive an acknowledgement message from the second station, where the acknowledgement message is used to indicate that the second station has received the first OSC signal. In this embodiment, after receiving the first OSC signal, the second station sends the acknowledgement message to the first station, to acknowledge that the first OSC signal has been received, so that the first station can accurately switch an optical path. In another embodiment, the first station may alternatively switch an optical path a preset time after sending of the first OSC signal.

In still another embodiment, the optical path selector is a 2×2 optical switch. In this embodiment, switching between two optical paths can be simply implemented by using the 2×2 optical switch.

In still another embodiment, the fiber interface unit is further configured to send a third OSC signal to the second station, where the third OSC signal includes an updated time of the first station. In this embodiment, the first station periodically sends the updated time of the first station, so that the second station can implement time synchronization with the first station based on the updated time of the first station and the unidirectional transmission delay.

According to the station provided in this embodiment of the present disclosure, the optical path selector is used to switch an optical path, so that two OSC signals including time stamps are transmitted on a same fiber in which a difference between wavelength values is less than the preset range, and a unidirectional transmission delay between two stations can be accurately measured based on the time stamps.

An embodiment of the present disclosure further provides still another second station. A hardware structure of the second station is shown by an OSC signal sending structure in a station B in FIG. 3A and FIG. 3B or FIG. 6A and FIG. 6B. The second station may include a controller, an optical path selector connected to the controller, and a fiber interface unit connected to the optical path selector. In FIG. 3A and FIG. 3B, and FIG. 6A and FIG. 6B, the controller is an FPGA chip, the optical path selector is a 2×2 optical switch, and the fiber interface unit is an FIU.

The controller is configured to control the optical path selector to work in a first state, so that the fiber interface unit selects a first fiber to receive a first optical supervisory channel OSC signal from a first station, where the first OSC signal includes a first time stamp, and the first time stamp indicates a first sending moment at which the first station sends the first OSC signal.

The controller is further configured to control the optical path selector to work in a second state, so that the fiber interface unit selects the first fiber to send a second OSC signal to the first station, where the second OSC signal includes a second time stamp, the second time stamp indicates a first receiving moment at which the second station receives the first OSC signal and a second sending moment at which the second station sends the second OSC signal, and a difference between a value of a wavelength used by the first OSC signal and a value of a wavelength used by the second OSC signal is less than a preset range.

In one embodiment, the difference between the value of the wavelength used by the first OSC signal and the value of the wavelength used by the second OSC signal is 0. In this embodiment, a difference between values of wavelengths used by two OSC signals is 0, so that a measured unidirectional transmission delay can be completely error-free.

In another embodiment, the fiber interface unit is further configured to send an acknowledgement message to the first station, where the acknowledgement message is used to indicate that the second station has received the first OSC signal. In this embodiment, after receiving the first OSC signal, the second station sends the acknowledgement message to the first station, to acknowledge that the first OSC signal has been received, so that the first station can accurately switch an optical path. In another embodiment, the first station may alternatively switch an optical path a preset time after sending of the first OSC signal.

In still another embodiment, the controller is configured to control, based on a change of an optical power on the first fiber, the optical path selector to work in the second state. In this embodiment, the first station does not need to notify the second station of a change of an optical path, and when the first station switches a status of an optical path selector, the second station may switch a status of the optical path selector of the second station based on the change of the optical power on the fiber. In one embodiment, there is no light on the fiber, and the optical power is 0.

In still another embodiment, the fiber interface unit is further configured to receive a unidirectional transmission delay sent by the first station. In this embodiment, after obtaining the unidirectional transmission delay through calculation, the first station sends the unidirectional transmission delay to the second station, so that the second station can perform time synchronization based on the unidirectional transmission delay and a time of the first station.

In still another embodiment, the controller is further configured to synchronize a time of the second station with a time of the first station based on the unidirectional transmission delay and the time of the first station. In this embodiment, the second station can accurately perform time synchronization based on the unidirectional transmission delay and the time of the first station.

In still another embodiment, the fiber interface unit is further configured to receive a third OSC signal sent by the first station, where the third OSC signal includes an updated time of the first station. The second station updates the time of the second station based on the updated time of the first station and the unidirectional transmission delay. In this embodiment, the first station periodically sends the updated time of the first station, so that the second station can accurately implement time synchronization with the first station based on the updated time of the first station and the unidirectional transmission delay.

In still another embodiment, the unidirectional transmission delay is a half of a difference between a first operation value and a second operation value, the first operation value is a difference between a second receiving moment and the first sending moment, and the second operation value is a difference between the second sending moment and the first receiving moment. In this embodiment, the unidirectional transmission delay is calculated based on moments at which each of two stations sends and receives OSC signals and that are recorded in time stamps.

In still another embodiment, the optical path selector is a 2×2 optical switch. In this embodiment, switching between two optical paths can be simply implemented by using the 2×2 optical switch.

According to the station provided in this embodiment, the optical path selector is used to switch an optical path, so that two OSC signals including time stamps are transmitted on a same fiber in which a difference between wavelength values is less than the preset range, and a unidirectional transmission delay between two stations can be accurately measured based on the time stamps.

A person of ordinary skill in the art may be aware that units and algorithm steps in the examples described with reference to the embodiments disclosed in this specification can be implemented by electronic hardware or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of this application.

It may be clearly understood by a person skilled in the art that, for the purpose of convenient and brief description, for a detailed working process of the foregoing system, apparatus, and unit, refer to a corresponding process in the foregoing method embodiments. Details are not described herein again.

In the several embodiments provided in this application, it should be understood that the disclosed system, apparatus, and method may be implemented in other manners. For example, the described apparatus embodiment is merely an example. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected based on actual requirements to achieve the objectives of the solutions of the embodiments.

In addition, functional units in the embodiments of this application may be integrated into one processing unit, or each of the units may exist alone physically, or two or more units are integrated into one unit.

All or some of the foregoing embodiments may be implemented by using software, hardware, firmware, or any combination thereof. When software is used to implement the embodiments, the embodiments may be implemented completely or partially in a form of a computer program product. The computer program product includes one or more computer instructions. When the computer program instructions are loaded and executed on a computer, the procedure or functions according to the embodiments of the present disclosure are all or partially generated. The computer may be a general-purpose computer, a dedicated computer, a computer network, or other programmable apparatuses. The computer instruction may be stored in a computer-readable storage medium, or may be transmitted by using the computer-readable storage medium. The computer instruction may be transmitted from one web site, computer, server, or data center to another web site, computer, server, or data center in a wired (for example, a coaxial cable, a fiber, or a digital subscriber line (DSL)) or wireless (for example, infrared, wireless, or microwave) manner. The computer-readable storage medium may be any usable medium accessible by a computer, or a data storage device, such as a server or a data center, integrating one or more usable media. The usable medium may be a magnetic medium (for example, a floppy disk, a hard disk, or a magnetic tape), an optical medium (for example, a DVD), a semiconductor medium (for example, a solid state disk (SSD)), or the like.

A person of ordinary skill in the art may understand that all or some of the processes of the methods in the embodiments may be implemented by a computer program instructing related hardware. The program may be stored in a computer-readable storage medium. When the program runs, the processes of the methods in the embodiments are performed. The foregoing storage medium includes: any medium that can store program code, for example, a read-only memory (ROM), a random access memory (RAM), a magnetic disk, or an optical disc.

What is claimed is:

1. A method of measuring a transmission delay between stations, comprising:
controlling, by a first station, an optical path selector to work in a first state, selecting, by the first station, a first fiber to send a first optical supervisory channel (OSC) signal to a second station, wherein the first OSC signal comprises a first time stamp, and the first time stamp indicates a first sending moment at which the first station sends the first OSC signal;
controlling, by the first station, the optical path selector to work in a second state, selecting, by the first station, the first fiber to receive a second OSC signal from the second station at a second receiving moment, wherein the second OSC signal comprises a second time stamp, the second time stamp indicates a first receiving moment at which the second station receives the first OSC signal and a second sending moment at which the second station sends the second OSC signal, and a difference between a value of a wavelength used by the first OSC signal and a value of a wavelength used by the second OSC signal is less than a preset value; and
calculating, by the first station, a unidirectional transmission delay between the first station and the second station based on the first sending moment, the first receiving moment, the second sending moment, and the second receiving moment.

2. The method according to claim 1, wherein the difference between the value of the wavelength used by the first OSC signal and the value of the wavelength used by the second OSC signal is 0.

3. The method according to claim 1, wherein the unidirectional transmission delay is a half of a difference between a first operation value and a second operation value, the first operation value is a difference between the second receiving moment and the first sending moment, and the second operation value is a difference between the second sending moment and the first receiving moment.

4. The method according to claim 1, further comprising: after calculating the unidirectional transmission delay between the first station and the second station based on the first sending moment, the first receiving moment, the second sending moment, and the second receiving moment,
sending, by the first station, the unidirectional transmission delay to the second station.

5. The method according to claim 1, further comprising: after selecting the first fiber to send the first OSC signal to the second station,
receiving, by the first station, an acknowledgement message from the second station, wherein the acknowledgement message is used to indicate that the second station has received the first OSC signal.

6. The method according to claim 1, wherein the optical path selector is a 2×2 optical switch.

7. A method of measuring a transmission delay between stations, comprising:
controlling, by a second station, an optical path selector to work in a first state, selecting, by the second station, a first fiber to receive a first optical supervisory channel (OSC) signal from a first station, wherein the first OSC signal comprises a first time stamp, and the first time stamp indicates a first sending moment at which the first station sends the first OSC signal; and
controlling, by the second station, the optical path selector to work in a second state, selecting, by the second station, the first fiber to send a second OSC signal to the first station, wherein the second OSC signal comprises a second time stamp, the second time stamp indicates a first receiving moment at which the second station receives the first OSC signal and a second sending moment at which the second station sends the second OSC signal, and a difference between a value of a wavelength used by the first OSC signal and a value of a wavelength used by the second OSC signal is less than a preset value.

8. The method according to claim 7, wherein the difference between the value of the wavelength used by the first OSC signal and the value of the wavelength used by the second OSC signal is 0.

9. The method according to claim 7, wherein a unidirectional transmission delay is a half of a difference between a first operation value and a second operation value, the first operation value is a difference between a second receiving moment at which the first station receives the second OSC signal and the first sending moment, and the second operation value is a difference between the second sending moment and the first receiving moment.

10. The method according to claim 7, further comprising: after selecting the first fiber to send the second OSC signal to the first station,
receiving, by the second station, the unidirectional transmission delay sent by the first station.

11. The method according to claim 10, further comprising: after receiving, by the second station, the unidirectional transmission delay sent by the first station,
synchronizing, by the second station, a time of the second station with a time of the first station based on the unidirectional transmission delay and the time of the first station.

12. The method according to claim 7, wherein controlling, by the second station, the optical path selector to work in the second state comprises:
controlling, by the second station based on a change of an optical power on the first fiber, the optical path selector to work in the second state.

13. The method according to claim 7, further comprising: after selecting the first fiber to receive the first OSC signal from the first station, sending, by the second station, an acknowledgement message to the first station, wherein the acknowledgement message is used to indicate that the second station has received the first OSC signal.

14. The method according to claim 7, wherein the optical path selector is a 2×2 optical switch.

15. A first station, comprising:
a controller;
an optical path selector connected to the controller; and
a fiber interface unit connected to the optical path selector;
wherein the controller is configured to control the optical path selector to work in a first state, the fiber interface unit is configured to select a first fiber to send a first optical supervisory channel (OSC) signal to a second station, wherein the first OSC signal comprises a first time stamp, and the first time stamp indicates a first sending moment at which the first station sends the first OSC signal,
wherein the controller is further configured to control the optical path selector to work in a second state, the fiber interface unit is configured to select the first fiber to receive a second OSC signal from the second station at a second receiving moment, wherein the second OSC signal comprises a second time stamp, the second time stamp indicates a first receiving moment at which the second station receives the first OSC signal and a second sending moment at which the second station sends the second OSC signal, and a difference between a value of a wavelength used by the first OSC signal and a value of a wavelength used by the second OSC signal is less than a preset value, and
wherein the controller is further configured to calculate a unidirectional transmission delay between the first station and the second station based on the first sending moment, the first receiving moment, the second sending moment, and the second receiving moment.

16. The first station according to claim 15, wherein the difference between the value of the wavelength used by the first OSC signal and the value of the wavelength used by the second OSC signal is 0.

17. The first station according to claim 15, wherein the unidirectional transmission delay is a half of a difference between a first operation value and a second operation value, the first operation value is a difference between the second receiving moment and the first sending moment, and the second operation value is a difference between the second sending moment and the first receiving moment.

18. A second station, comprising:
a controller;
an optical path selector connected to the controller; and
a fiber interface unit connected to the optical path selector;
wherein the controller is configured to control the optical path selector to work in a first state, the fiber interface unit is configured to select a first fiber to receive a first optical supervisory channel (OSC) signal from a first station, wherein the first OSC signal comprises a first time stamp, and the first time stamp indicates a first sending moment at which the first station sends the first OSC signal, and
wherein the controller is further configured to control the optical path selector to work in a second state, the fiber interface unit is configured to select the first fiber to send a second OSC signal to the first station, wherein the second OSC signal comprises a second time stamp, the second time stamp indicates a first receiving moment at which the second station receives the first OSC signal and a second sending moment at which the second station sends the second OSC signal, and a difference between a value of a wavelength used by the first OSC signal and a value of a wavelength used by the second OSC signal is less than a preset value.

19. The second station according to claim 18, wherein the difference between the value of the wavelength used by the first OSC signal and the value of the wavelength used by the second OSC signal is 0.

20. The second station according to claim 18, wherein the unidirectional transmission delay is a half of a difference between a first operation value and a second operation value, the first operation value is a difference between a second receiving moment at which the first station receives the second OSC signal and the first sending moment, and the second operation value is a difference between the second sending moment and the first receiving moment.
